(19) United States
(12) Patent Application Publication
(10) Pub. No.: US 2011/0179628 A1
(43) Pub. Date: Jul. 28, 2011

(54) METHOD FOR ARRANGING AND FASTENING A DECORATIVE STRIP IN THE REGION OF A MOTOR VEHICLE WINDOW

(75) Inventor: Bernhard Kreye, Wunstorf (DE)

(73) Assignee: HENNIGES Automotive GmbH & Co. KG, Rehburg-Loccum (DE)

(21) Appl. No.: 12/737,055

(22) PCT Filed: Jun. 3, 2009
(86) PCT No.: PCT/DE2009/000766

§ 371 Date: Mar. 28, 2011

(30) Foreign Application Priority Data
Jun. 5, 2008 (DE) 10 2008 026 923.9

(51) Int. Cl. B23P 11/02

(52) U.S. Cl. 29/450

(57) ABSTRACT

The invention relates to a method for arranging and fastening a decorative strip (2) in the region of a window (3) of a motor vehicle, wherein the decorative strip is connected to a profiled part (1) that serves as a decorative strip carrier. The thus prepared profiled part is then connected to a connecting profile (4) that is stationarily arranged in the region of the window. According to the invention, a soft elastic material is used as material for the profiled part and a projecting base area (11) of the profiled part is subjected to pressure from the outside and is squeezed into a narrow receiving element (6) of the decorative strip while its outer contour is deformed, the receiving element being located on the bottom side of the decorative strip, facing away from the visible side. The application of pressure is subsequently suspended and the base area (10) of the profiled part, which projects from the receiving element, is inserted into a recess (17) of the connecting profile and is thus locked in a positive fit. The material used for the profiled part is a plastic material having a Shore hardness from 30 to 90 Shore A.

The invention relates to a method for arranging and fastening a decorative strip in the region of a window of a motor vehicle, wherein the decorative strip is connected to a profiled part that serves as a decorative strip carrier and the profiled part thus prepared is then connected to a connecting profile that is fixedly arranged in the region of the window.

It has already been suggested to connect decorative strips to a profiled part serving as a decorative strip carrier and to then connect the profiled part thus prepared to a connecting profile fastened in the area of the window either on the bodywork or on the window pane made of glass.

The fastening of the connecting profile can be accomplished, for example, by means of adhesive bonding, latching with previously attached clips, push buttons, brackets and the like auxiliary means.

Decorative strips are usually profiled rails made of metal, e.g. steel sheet or aluminium having a material thickness of about 1 mm. The decorative strips are stamped, embossed, rolled or drawn from metal material and usually polished or also chrome-plated on the visible side.

The known decorative strips are likewise connected to a base part which supports the decorative strips, e.g. the profiled part proposed as a profile carrier, by means of adhesive or latching, in which case more or less expensive mounting processes need to be undertaken, in particular for the application of pre-fabricated clips, brackets, or plugs and the like fastening means, for example, made of plastic.

It is the object of the invention to arrange and fasten a decorative strip in the area of a window without additional fastening means such as adhesive, clips, brackets and the like.

This object is achieved according to the invention by the measures according to patent claim 1.

Further developments and advantageous embodiments are obtained from claims 2 and 3.

Since a soft elastic material such as, for example, TPE, soft PVC, PU or rubber having a hardness of 30 to 90 Shore A is used as material for the profiled part used as the decorative strip carrier, the base area of the profiled part formed therefrom can be squeezed into a receiving element of the decorative strip whilst applying suitable pressure, whereby the connection is made. Said receiving element is located on the underside of the decorative strip facing away from the visible surface, and can be formed, for example, by the longitudinal edges of a metal strip, which is used for the decorative strip, being bent more or less inwards towards the underside so that on the longitudinal edges of the metal strip used as the decorative strip, edges approximately similar to undercuts are provided, which edges delimit the receiving element.

As a result, a receiving space is provided under the bent longitudinal edges which is delimited by the underside surface of the decorative strip, facing away from its visible surface, and the bent-back longitudinal edges of the decorative strip.

Naturally it is also possible to form a corresponding receiving element on the underside of a decorative strip by other measures. Thus, for example, the decorative strip can also be a chamber profile extruded from aluminium in which an outwardly open chamber can fulfil the function of the receiving element.

The profiled part has a cross-sectional shape in which a base area is provided which has a, for example, approximately mushroom-like shape.

This mushroom-like base area can, according to the invention, be squeezed into the narrow receiving element with appropriate compressive force, whereby the profiled part and the decorative strip are interconnected. The profiled part can be successively subjected to the compressive force in some areas so that the .soft elastic profiled part is approximately “linked” to the receiving element or ultimately to the decorative strip.

The moulded part with its base area is almost “rolled-in” into the receiving element of the decorative strip, where a roller which can be guided from outside and thereby pressed against the profiled part could be used.

Due to the squeezing of the soft-elastic base area, this section of the profiled part deforms to such an extent that it can be inserted into the receiving element of the decorative strip. As soon as the squeezing pressure is released, the deformed base area springs back into its original shape and is snapped in and locked or fixed behind the projecting longitudinal edges of the decorative strip which delimit the receiving element.

The decorative strip is thereby connected to the profiled part without additional auxiliary means. Profile part and decorative strip form a structural unit which can be supplied for further use.

The further use consists in then arranging and fastening the structural unit comprising decorative strip and profiled part according to the invention in the area of a window by means of a connecting profile.

This is achieved by a top area being moulded on the profiled part in addition to the moulding of its base area. The top area can also have a mushroom-like cross-sectional shape whereby the top area can again be locked positively to the connecting profile. For this purpose the connecting profile has corresponding recesses in which the top area can be placed and thereby locked.

The placement of the top area in the associated recess is also a process in which squeezing pressure is used, with the effect that the top area of the profiled part inserted into the recess can then barely be further deformed since it has become almost firm and undeformable as a result of the squeezing holding pressure acting both on its base area and simultaneously on its top area, especially as the bordering surfaces of the receiving element of the decorative strip and the recess of the connecting profile would hinder any further squeezing together of the material of the profiled part as a result of their function of forming a counter-bearing for the compressive forces.

The capacity of the material to be able to escape squeezing deformation diminishes proportionally to the increasing squeezing pressure during the joining together of the components. This is also the case when fastening the decorative strip on the profiled part.

In order that the compressive forces to be applied for the squeezing are not allowed to become too great, it is provided according to an advantageous further development that recesses are formed in the outer surfaces of the profiled part, in particular in the outer surfaces of base area and top area of the profiled part, by which means their squeezing deformability is increased.

The squeeze-deformed material can be deformed into the respective recess, wherein internal squeezing pressure which could prevent a further deformation can be at least partially reduced again.

For a recycling process, for example, the decorative strip fastened according to the invention can particularly advantageously only be dismounted when the squeezing pressure on the top area of the profiled part is released. This can be accomplished, for example, by withdrawing the top area of the profiled part from the recess in the connecting profile. Thereafter, the decorative strip can be peeled out with relatively little effort from the profiled part now present again as a structural unit which can be handled freely.

An exemplary embodiment from which further inventive features are obtained is shown in the drawings. In the figures:

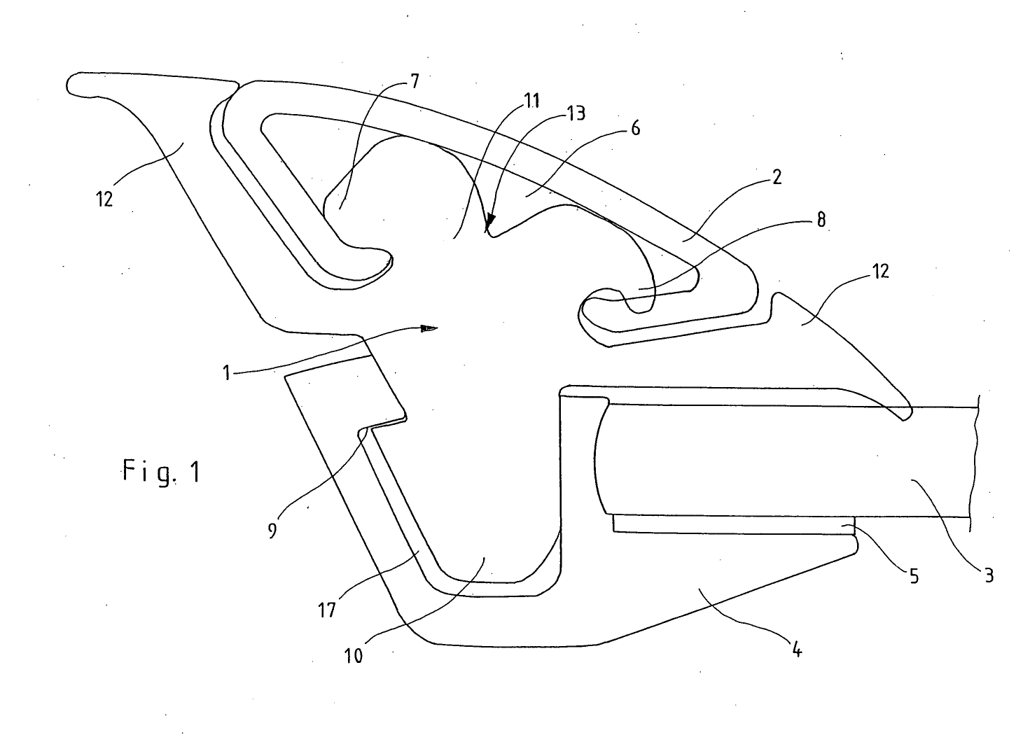

FIG. 1: shows a schematic side view of a window area of a motor vehicle in cross-section,

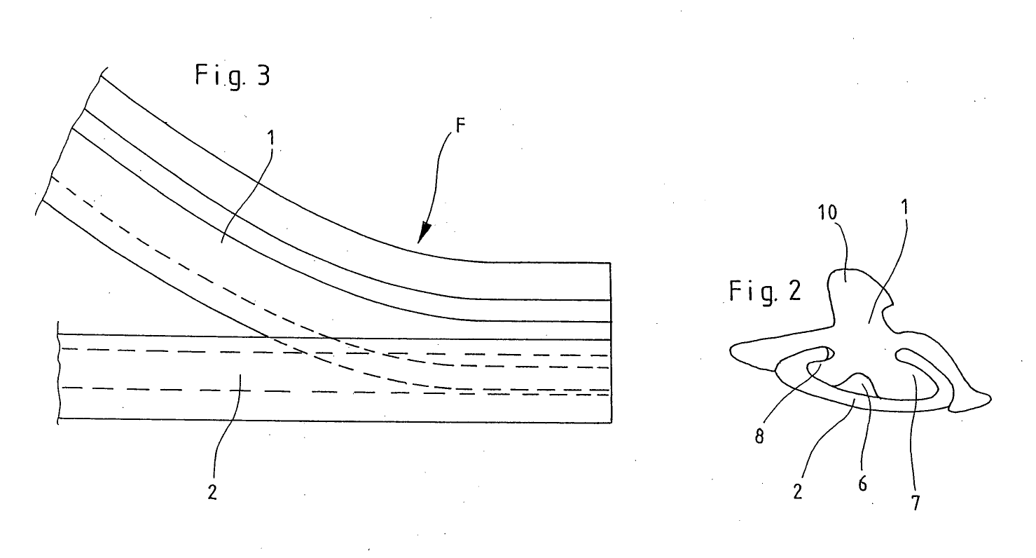

FIG. 2: is a side view of a structural unit consisting of profiled part and decorative strip fastened thereon and

FIG. 3: is a schematic side view of the decorative strip at the instant of joining together or connecting to a profiled part to form the structural unit according to FIG. 2.

FIG. 1 shows in a schematic side view an edge of a window area of a motor vehicle. A glass pane of the window is designated by 3. A frame profile 4 made of relatively hard material is glued to the window pane 3 made of glass with adhesive 5.

The connecting profile 4 has a moulded-in recess 17 and has a moulded-on latching lug 9 in the area of the upper opening edge.

The profiled part 1 is made separately from soft-elastic material having a hardness of 30 to 90 Shore A. The profiled part 1 has a top area 10 which can be pressed into the recess 17 and can be locked to the latching lug 9.

The profiled part 1 is pressed into the receiving element 6 on the underside of a decorative strip 2 made of metal, with a base area 11 which is delimited by lateral latching lugs 7 and 8. By being pressed into the receiving element 6, the latching lugs 7 and 8 snap into the receiving element as far as the base area 11.

Lateral compensating lips of the profiled part 1 are designated by 12.

The recess designated here by 13, which increases the squeezing deformability of the profiled part 1 is moulded into the outer surface of the base area 11.

FIG. 2 shows a structural unit formed by joining together decorative strip 2 and profiled part 1. The same components are designated with the same reference numbers as in FIG. 1.

FIG. 3 shows a schematic side view and illustrates how the profiled part 1 is linked to the decorative profile 2, by applying the force F to the moulded part 1 in the linking area.

As soon as the structural unit formed from the profiled part 1 and decorative strip 2 joined together in this manner is present, the arrangement and fastening can be carried out as shown in FIG. 1.

1. A method for arranging and fastening a decorative strip in the region of a window of a motor vehicle, wherein the decorative strip is connected to a profiled part (1) that serves as a decorative strip carrier and the profiled part thus prepared is then connected to a connecting profile that is fixedly arranged in the region of the window, wherein a soft elastic material is used as material for the profiled part (1), a projecting base area (11) of the profiled part (1) is subjected to pressure from outside and is squeezed into a narrow receiving element (6) of the decorative strip (2) whilst its outer contour is deformed, said receiving element being located on the underside of the decorative strip (6) facing away from the visible side, and subsequently the application of pressure is suspended and the top area of the profiled part (1), which projects from the receiving element (6), is inserted into a recess (17) of the connecting profile (4) and is thereby locked in a positive fit.

2. The method according to claim 1, wherein plastic material having a hardness of 30 to 90 Shore A is used as material for the profiled part (1)

3. The method according to claim 1, wherein recesses (13) are formed in the outer surfaces of the profiled part (1), in particular in the outer surfaces of base area (11) and top area (10) of the profiled part (1), by which means their squeezing deformability is increased.
